(19) United States
(12) Patent Application Publication
(10) Pub. No.: US 2001/0030104 A1
(43) Pub. Date: Oct. 18, 2001

(54) Method and apparatus for stacking thermoplastic containers

(76) Inventors: Stefan Schlimgen, Heilbronn-Bockingen (DE); Michael Wozny, Heilbronn (DE)

Correspondence Address: VENABLE, P.O. Box 34385, Washington, DC, 20043-9998, US

(21) Appl. No.: 09/764,145

(22) Filed: Jan. 19, 2001

Related U.S. Application Data
(63) Continuation of application No. 09/617,794.

(30) Foreign Application Priority Data
Jul. 16, 1999 (DE) 199 33 354.8

(51) Int. Cl. B65G 57/00

(52) U.S. Cl. 198/418.4

(57) ABSTRACT

To improve the stacking of containers comprising thermoplastic plastic, and the transfer of the stacks to a successive device, the containers ejected from a shaping tool are alternatingly received by two retaining plates and guided to two respective stack magazines disposed to the side of the shaping tool. These magazines can be exchanged alternatingly with an adjacent stack magazine and guided into an ejection station.

### CROSS-REFERENCE TO RELATED APPLICATION

This application is a continuation of U.S. application Ser. No. 09/617,794, filed Jul. 17, 2000.

This application is related to concurrently filed U.S. application Ser. No. (Attorney Docket No. 31713-164688), which is a continuation of U.S. application Ser. No. 09/617,793 filed Jul. 17, 2000.

### BACKGROUND OF THE INVENTION

The invention relates to a method for stacking containers that have been shaped and punched from a sheet of thermoplastic plastic in a shaping tool, and guided to stack magazines by a transfer device, and for transferring the stacks to a successive device. The invention further relates to an apparatus for executing the method.

German Utility Patent 296 08 477 discloses inserting containers that have been shaped and punched in a shaping tool into a pallet belt by a transfer device, which is fed cyclically to a stacking station. There, the containers are transferred into vertical stack magazines. A lower part of the stacking device is stationary, while an upper part is displaceable in height and pivotable. Once a specific number of containers is located in the upper stack magazine, the magazine is raised and tipped. With multiple rows of stacks, the stacks are pushed in rows onto a transversely-extending conveyor belt, which feeds the stacks individually and cyclically to a longitudinally-extending transport belt. All of the containers leave the apparatus in a stack, and are fed to a single finishing station or packaging station.

A disadvantage of this method is that it requires a voluminous apparatus that is disposed in the ejection region of the shaping tool. This apparatus impedes the accessibility of the shaping tool, for example, in the event of a fault, in the exchange of the tool, in observation during startup and production, and in the removal of the startup waste.

The division of the stacking device into a fixed and a movable stack magazine is necessary to ensure continued operation during the emptying of the height-adjustable stack magazine, which requires more time than is available between two cycles of the shaping tool. When this magazine is returned to its initial position, it must be drawn across the stacks that have been formed in the interim; the higher the cycle number of the apparatus, the higher the stacks. This often causes disturbances or faults, leading to the shutdown and cleaning of the apparatus. The pallet belt requires a plurality of pallets having precise holes that correspond to the shape of the containers to be stacked, which is costly and stipulates time for changeovers.

It is known from German Patent documents DE 298 02 318 U1 and DE PS 26 48 563 C2 to embody stack magazines in two parts, namely one stationary and one movable part. These two documents do not disclose a consecutive guidance of the stacks. They would have to be taken up again, a process that would be susceptible to disturbances.

A further drawback of these known stacking methods is that the number of stacked containers in the stationary stack magazine during the time of the transfer of the stacks by the movable stack magazine is a function of the cycle number of the shaping tool. The transfer time of the stacks is constant because of the established paths and speeds of the drives. This means, however, that a varying number of containers is shaped and stacked during this transfer time, depending on the number of cycles. This is significant, and is associated with control problems, if stacks are to be formed from a specific number of containers. A further drawback of the known stacking methods is that the containers must be pressed over two stacking edges, which always poses a risk of deformation.

It is the object of the invention to provide a method to create stacks of a predetermined number of containers, regardless of the cycle number of the shaping tool, and independently of the time required for transferring the stacks to successive devices. The method is intended to be insusceptible to disturbances, particularly with high cycle numbers of the shaping tool, which requires that the containers be transferred quickly into stack magazines. The method should not necessitate an apparatus that adjusts the ejection region of the shaping tool, so this region is relatively accessible and visible. Furthermore, the method should permit a fast changeover of the apparatus for a different container format.

### SUMMARY OF THE INVENTION

The above object generally is achieved amending to a first aspect of the invention by a method for stacking containers that have been shaped and punched from a sheet of thermoplastic plastic in a shaping tool and guided by a transfer device to stack magazines, and for transferring the stacks to a transport device for transport to a successive device, said method, which method comprises alternately retaining the containers ejected from the lower part of the shaping tool by a respective one of two retaining plates that can be displaced perpendicular to the direction of ejection; guiding each retaining plate to a respective laterally disposed stacking station; transferring the containers into respective first stack magazines at the respective stacking stations; at each stacking station, transferring the stack magazine to a respective ejection station once a predetermined number of containers, or a specified stack length, has been attained in the stack magazine; at each stacking station, guiding an empty stack magazine out of the respective ejection station and into the stacking station when the first stack magazine is transferred out; and, ejecting the stacks from the respective stack magazines located in the ejection station and transferring the stacks onto the transport device.

The above object generally is achieved amending to a second aspect of the invention by an apparatus for stacking containers that have been shaped and punched from a sheet of thermoplastic plastic in a shaping tool, with said apparatus comprising a device for gripping the containers that have been ejected from the shaping tool at the ejection station, stack magazines for receiving the containers at a stacking station, and a device for transferring the stacks from the stack magazines onto a transport device disposed at an ejection station; and wherein: the device for gripping and transferring the containers comprises two retaining plates that are each mounted for displacing as between the ejection position for the lower part of the shaping tool and a respective stacking station; a respective ejection station is disposed next to each stacking station; at each stacking station, two stack magazines are mounted between each stacking station and its respective associated ejection station; and an ejection device for emptying the stack magazines is disposed in each ejection station.

The method is described in detail in conjunction with the schematic drawings of the apparatus.

### BRIEF DESCRIPTION OF THE DRAWINGS

FIG. 1 is a longitudinal section through the shaping tool in the ejection position of an apparatus according to the invention.

FIG. 2 is a plan view of the apparatus of FIG. 1.

FIG. 3 is a view in the direction X in FIG. 2.

### DETAILED DESCRIPTION OF THE PREFERRED EMBODIMENTS

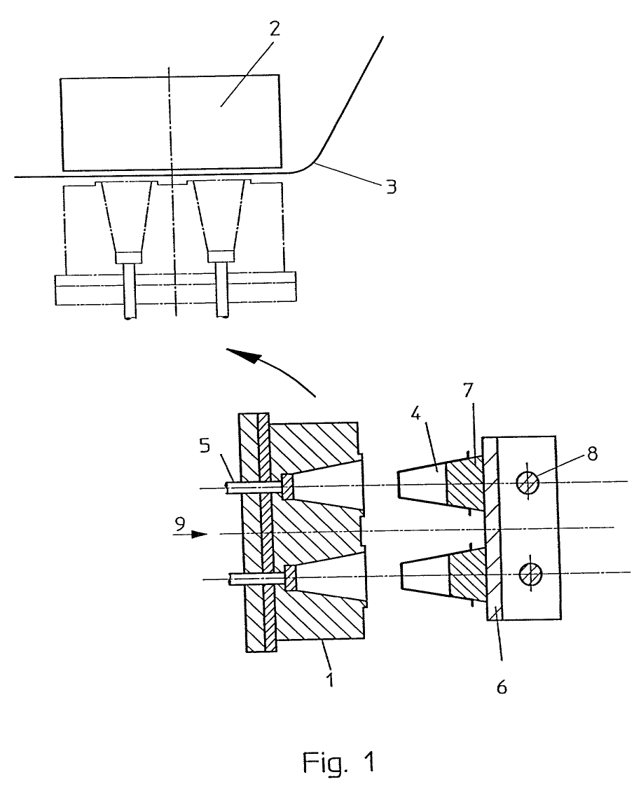

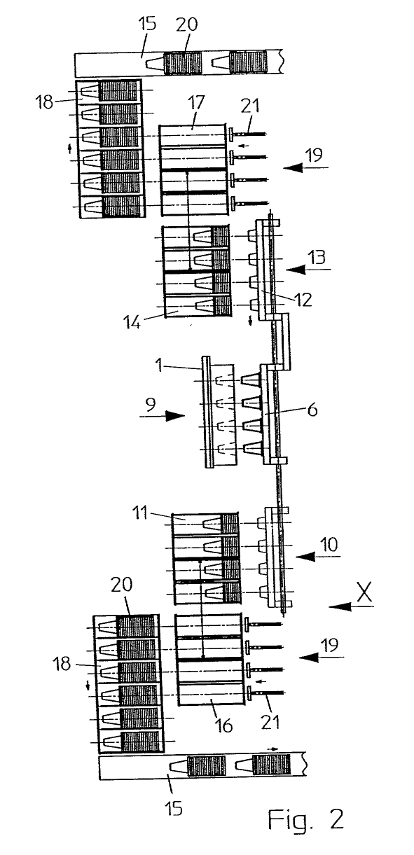

FIG. 1 illustrates a lower part 1 of a combined shaping/punching tool, which can be pivoted out of the shaping position shown in a dot-dash line, in which containers 4 are shaped and punched from a sheet 3 in cooperation with an upper part 2 of the combined shaping/punching tool, and into an ejection position 9. Ejectors 5 eject the containers 4 from the lower part 1 located in the ejection position 9. The ejected containers are received by a retaining plate 6. This is effected by means of a vacuum and/or additional receiving arbors 7, possibly with a form-fit. The retaining plate 6 is displaceable, in a direction perpendicular to the direction of ejection of the containers 4, on guides 8 from the ejection position 9 into a lateral stacking station 10 (FIG. 2), in which a stack magazine 11 is disposed. The containers 4 are stacked in this magazine 11, for which purpose a relative movement is initiated between the stack magazine 11 and the retaining plate 6 in a manner that is not illustrated. While the retaining plate 6 is located in this stacking position 10, a second retaining plate 12 stands in front of the lower part 1 in the ejection position 9 for receiving the containers 4 that will be ejected during the next cycle, and subsequently, and in a similar manner to retaining plate 6, guiding the containers to a stacking station 13 with a second stack magazine 14 located on the opposite side of the ejection station 9. Because the two retaining plates 6, 12 perform synchronous movements, they can be connected to one another and moved by a common drive. Two separate drives can also be used, however, which offers the advantage of making the front side of the lower part freely accessible.

This stacking principle is applicable if the shaping tool has a high cycle number, because twice the cycle time remains for transferring the containers 4 into the lateral stack magazines 11 and 14. Because the stacks 20 being formed in the stack magazines 11, 14 must be removed from the magazines when a predetermined number of containers has been attained, then possibly guided consecutively to a single conveyor belt 15, this clearing requires more time than is available between two cycles. Most importantly, in the multiple-row travel of the shaping tool, the superposed stack rows must be pushed in rows out of the stack magazines 11, 14 and onto a transverse conveyor belt 18.

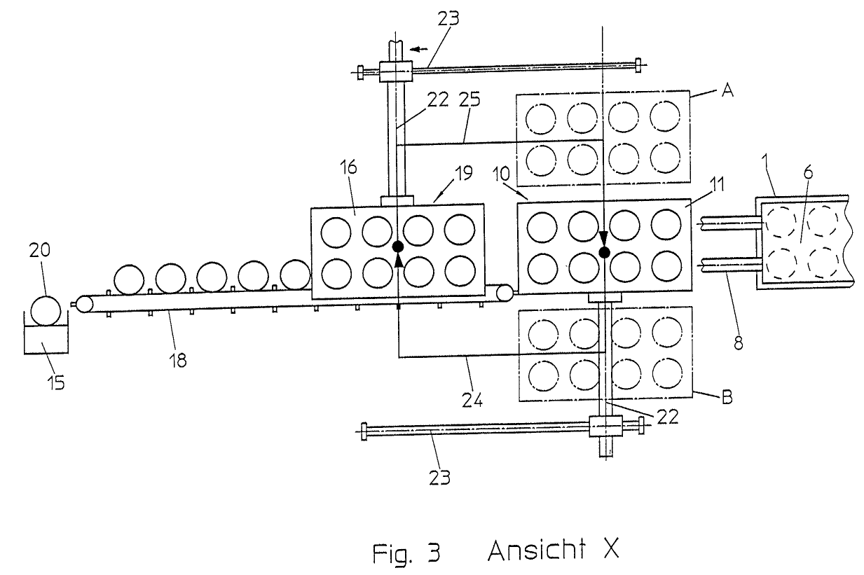

To attain this, each stack magazine 11, 14 has an adjacent, associated stack magazine 16, 17, respectively, with which it can be exchanged at the respective stacking stations. FIG. 3 illustrates an advantageous design.

The stack magazines 11, 14, 16, 17 can be displaced vertically and horizontally by means of drives, not shown, with the magazines being guided on rods 22, 23. For exchanging the stack magazines, for example, the magazines 11 and 16, the empty magazine 16 is brought into a position A above the stack magazine 11 (FIG. 3) at the stacking station 10. Between two stacking cycles, the stack magazine 11 is lowered (position B), and the stack magazine 16 is brought into its position at the stacking station 10. While the second magazine 16 is being filled, the stack magazine 11 travels horizontally, and then upward again, into the ejection station 19, until the uppermost stack row of the magazine stops at the height of a transport device, which is illustrated in the form of a transverse conveyor belt 18. An ejection device 21 (FIG. 2) transfers a row of stacks 20 out of the magazine 11 onto the transverse conveyor belt 18. This belt transfers the stacks 20 cyclically onto a conveyor belt 15, or guides them in a different manner to a finishing station (for example, for bordering, sterilizing or packaging). When the transverse conveyor belt 18 is free again, the stack magazine 11 travels one step upward (position shown in FIG. 3), so the second row of stacks 20 can be pushed out of the magazine and onto the transverse conveyor belt 18 and transported further in the same way. The arrows 24, 25 indicate the movement performed by the stack magazines 11, 16.

Instead of the transverse conveyor belt 18, a sliding table can be used, which has receptacles for the individual stacks, and is intermittently guided to a transfer point. This solution permits a faster changeover to a different container format.

Once all of the stacks 20 have been removed from the stack magazines, the stack magazine 11 is again guided below the stack magazine 16 located in the stacking station 10 (i.e., position B). The exchange is effected by raising of both stack magazines 11, 16, so that the magazine 11 is in the stacking position 19 and a stack is formed again in the stack magazine 11. The stack magazine 16 is guided to the ejection station 19, and lowered there by rows, so first the lowermost row of stacks 20 can be transferred onto the transverse conveyor belt 18, then the second row and, if applicable, a third row.

The stack magazines 14, 17 are exchanged in the same manner.

The advantage of guiding the paired stack magazines 11, 16 and 14, 17 to a common ejection station 19 is that two stack magazines only require one ejection station 19, and thus only one ejection device 21, so the stacks 20 can be guided together more easily. If two stack magazines are connected and guided alternatingly into a stacking station 10 through a common displacement, two ejection stations are provided.

This method permits all of the containers 4 to be stacked directly, without a further transfer, in stack magazines 11, 14, 16, 17, and permits counted stacks 20 to be produced simply. The apparatus can be reset simply for a different container shape through an exchange of the stack magazines 11, 14, 16, 17 and a programming of the stroke required for clearing the individual stack rows. This can be done quickly and simply.

The invention now being fully described, it will be apparent to one of ordinary skill in the art that many changes and modifications can be made thereto without departing from the spirit or scope of the invention as set forth herein.

We claim:

1. A method for stacking containers that have been shaped and punched from a sheet of thermoplastic plastic in a shaping tool and guided by a transfer device to stack magazines, and for transferring the stacks to a transport device for transport to a successive device, said method comprising:
alternately retaining the containers ejected from a lower part of the shaping tool by a respective one of two retaining plates that can be displaced perpendicular to the direction of ejection;
guiding each retaining plate to a respective laterally disposed stacking station;
transferring the containers into respective first stack magazines at the respective stacking station;
at each stacking station, transferring the stack magazine to a respective ejection station once a predetermined number of containers, or a specified stack length, has been attained in the stack magazine;
at each stacking station, guiding an empty stack magazine out of the respective ejection station and into the stacking station when the first stack magazine is transferred out; and
ejecting the stacks from the respective stack magazines located in the ejection station and transferring the stacks onto the transport device.

2. The method according to claim 1, wherein the stack magazines are exchanged in each respective stacking station through a separate movement of the respective individual stack magazines.

3. The method according to claim 2, wherein the respective stack magazine located in the respective ejection station is positioned above or beneath the stack magazine located in the stacking station after emptying.

4. The method according to claim 1 wherein the stack magazines are multi-row magazines, and further comprising emptying the respective stack magazine located in the ejection station by rows.

5. The method according claim 1 wherein the stacks are transferred from the respective stack magazines onto a transverse conveyor belt, and, from this belt, are guided onto a longitudinal conveyor belt.

6. The method according to claim 1 wherein the stacks are transferred onto a sliding table in the ejection station, and, from this table, are guided to a longitudinal conveyor belt.

7. An apparatus for stacking containers that have been shaped and punched from a sheet of thermoplastic plastic in a shaping tool, comprising a device for gripping the containers that have been ejected from the shaping tool at the ejection station, stack magazines for receiving the containers at a stacking station, and a device for transferring the stacks from the stack magazines onto a transport device disposed at an ejection station; and wherein:
the device for gripping and transferring the containers comprises two retaining plates that are each mounted for displacement between the ejection position for the lower part of the shaping tool and a respective stacking station;
a respective ejection station is disposed next to each stacking station;
at each stacking station two stack magazines are mounted between each stacking station and its respective associated ejection station; and
a respective ejection device for emptying the stack magazines is disposed in each ejection station.

8. The apparatus according to claim 7, wherein the two retaining plates are coupled together, and are moved by a common drive.

9. The apparatus according to claim 7, wherein the two retaining plates are moved by separate drives.

10. The apparatus according to claim 7 wherein each stack magazine is displaceable via guides in vertical and horizontal directions, and has a drive for its horizontal and vertical displacement.

11. The apparatus according to claim 7 wherein the transport device is a transverse conveyor belt.

12. The apparatus according to claim 7 wherein the transport device is a sliding table.

13. The apparatus according to claim 11, wherein a longitudinal conveyor belt is disposed at the end of the transverse conveyor belt.
